(19) United States
(12) Patent Application Publication
(10) Pub. No.: US 2025/0108792 A1
(43) Pub. Date: Apr. 3, 2025

(54) INFORMATION PROCESSING APPARATUS, AUTONOMOUS VEHICLE, CONTROL METHOD OF INFORMATION PROCESSING APPARATUS, AND STORAGE MEDIUM

(71) Applicant: HONDA MOTOR CO., LTD., Tokyo (JP)

(72) Inventors: Jaechul KIM, Wako-shi (JP); Kota SAKAZAKI, Wako-shi (JP)

(21) Appl. No.: 18/891,896

(22) Filed: Sep. 20, 2024

(30) Foreign Application Priority Data
Sep. 28, 2023 (JP) 2023-168837

(51) Int. Cl. B60W 30/09; G06T 7/00; G06V 20/58

(52) U.S. Cl. CPC B60W 30/09; G06T 7/97; G06V 20/58

(57) ABSTRACT

An information processing apparatus comprising: a unit configured to acquire a first captured image by a first camera and a second captured image by a second camera; a unit configured to recognize an object from each the first captured image and the second captured image; a reliability calculation unit configured to calculate reliability indicating a probability that the object is the object for each the first captured image and the second captured image; a determination unit configured to determine whether an identical object is present in the first captured image and the second captured image; and a distance acquisition unit configured to acquire distance information to the object, based on an object recognition result for a captured image having higher reliability calculated by the reliability calculation unit, in a case where the determination unit determines that the identical object is present.

### CROSS-REFERENCE TO RELATED APPLICATION(S)

This application claims priority to and the benefit of Japanese Patent Application No. 2023-168837, filed Sep. 28, 2023, the entire disclosure of which is incorporated herein by reference.

### BACKGROUND OF THE INVENTION

### Field of the Invention

The present invention relates to an information processing apparatus, an autonomous vehicle, a control method of the information processing apparatus, and a storage medium.

### Description of the Related Art

International Publication No. 2021/014585 discloses that a marker included in a captured image and distance information from an autonomous work machine to the marker are stored beforehand in association with each other, and the distance information of the marker detected in a certain captured image is acquired.

In the technique described in International Publication No. 2021/014585, however, if the marker is partially or entirely hidden by the presence of a shielding object, it will not be possible to recognize the marker sufficiently. As a result, the distance information cannot be acquired, or erroneous distance information may be acquired.

### SUMMARY OF THE INVENTION

The present invention has been made in view of the above problems, and provides a technique for accurately acquiring the distance to an object.

According to one aspect of the present invention, there is provided an information processing apparatus comprising: an image acquisition unit configured to acquire a first captured image by a first camera and a second captured image by a second camera; an object recognition unit configured to recognize an object from each the first captured image and the second captured image; a reliability calculation unit configured to calculate reliability indicating a probability that the object is the object for each the first captured image and the second captured image; a determination unit configured to determine whether an identical object is present in the first captured image and the second captured image; and a distance acquisition unit configured to acquire distance information to the object, based on an object recognition result by the object recognition unit for a captured image having higher reliability calculated by the reliability calculation unit, in a case where the determination unit determines that the identical object is present.

### BRIEF DESCRIPTION OF THE DRAWINGS

FIG. 1 is an overhead view of an autonomous vehicle according to one embodiment;

FIG. 2 is a diagram illustrating an example of a hardware configuration of the autonomous vehicle according to one embodiment;

FIG. 3 is a diagram illustrating an example of a functional configuration of an information processing apparatus (ECU) included in the autonomous vehicle according to one embodiment;

FIG. 4 is an explanatory diagram of image transformation between captured images according to one embodiment; and

FIG. 5 is a flowchart illustrating a procedure of processing performed by the information processing apparatus according to one embodiment.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### <Overhead View of Autonomous Vehicle>

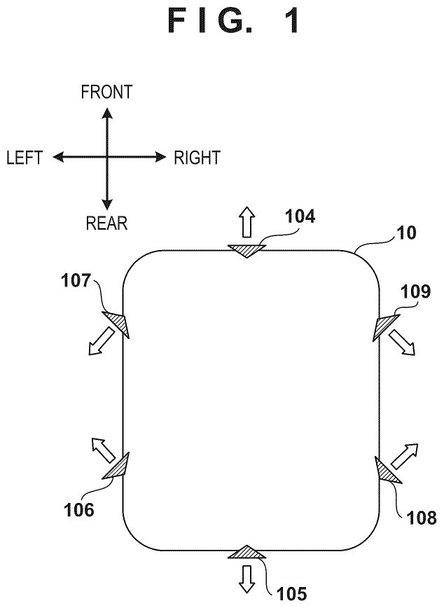

FIG. 1 illustrates an example of an overhead view of an autonomous vehicle according to the present embodiment. In the present embodiment, a vehicle that recognizes a surrounding situation and performs automated driving to autonomously control the vehicle, based on a recognition result will be described as an example. The autonomous vehicle may have any form, as long as it is a moving body that autonomously moves, and is, for example, a three-wheeled vehicle, a four-wheeled vehicle, or the like. In the present embodiment, a four-wheeled vehicle (electric vehicle) in which one or more occupants are able to get, for example, a micro mobility vehicle is applicable.

As illustrated in FIG. 1, an autonomous vehicle 10 includes a forward image capturing camera 104, a rearward image capturing camera 105, an obliquely forward left image capturing camera 106, an obliquely rearward left image capturing camera 107, an obliquely forward right image capturing camera 108, and an obliquely rearward right image capturing camera 109. Note that six cameras are provided in the illustrated example. However, the number of cameras is not limited to this example, and may be larger or smaller than six cameras.

The forward image capturing camera 104 denotes a camera installed on a front side of the autonomous vehicle 10 to capture images on a forward side of the vehicle. The rearward image capturing camera 105 denotes a camera installed on a rear side of the autonomous vehicle 10 to capture images on a rearward side of the vehicle. The obliquely forward left image capturing camera 106 denotes a camera installed on a left rear side of the autonomous vehicle 10 to capture images on an obliquely forward left side of the vehicle.

The obliquely rearward left image capturing camera 107 denotes a camera installed on a left front side of the autonomous vehicle 10 to capture images on an obliquely rearward left side of the vehicle. The obliquely forward right image capturing camera 108 denotes a camera installed on a right rear side of the autonomous vehicle 10 to capture images on an obliquely forward right side of the vehicle. The obliquely rearward right image capturing camera 109 denotes a camera installed on a right front side of the autonomous vehicle 10 to capture images on an obliquely rearward right side of the vehicle.

### <Hardware Configuration>

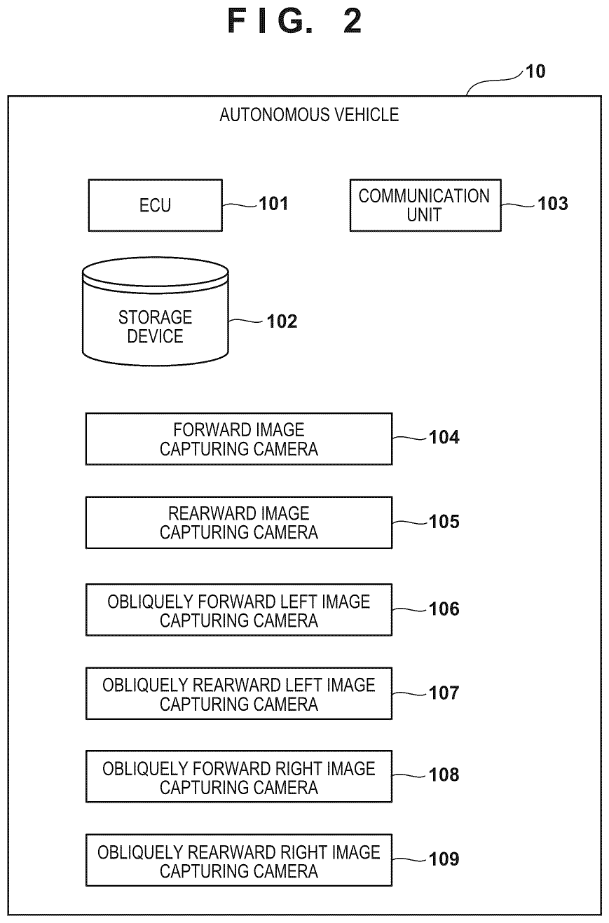

FIG. 2 is a diagram illustrating an example of a hardware configuration of the autonomous vehicle according to the present embodiment. The autonomous vehicle 10 includes an ECU 101, a storage device 102, a communication unit 103, and six cameras including the forward image capturing camera 104 to the obliquely rearward right image capturing camera 109, which have been described with reference to FIG. 1.

The ECU 101 is one or more electronic control units, and can function as an information processing apparatus. A control operation of the autonomous vehicle 10 is achieved by the ECU 101 reading and executing a computer program stored in the storage device 102. The storage device 102 is one or more memories that store several types of information. For example, information that has been received from another device, a computer program to be read and executed by the ECU 101, and the like are stored.

The communication unit 103 has a function of communicating with another device by wired or wireless communication through a network (not illustrated). The functions of the six cameras including the forward image capturing camera 104 to the obliquely rearward right image capturing camera 109 are as described with reference to FIG. 1. The ECU 101 controls the movement of the autonomous vehicle 10, based on the captured images acquired by the respective cameras including the forward image capturing camera 104 to the obliquely rearward right image capturing camera 109.

### <Functional Configuration>

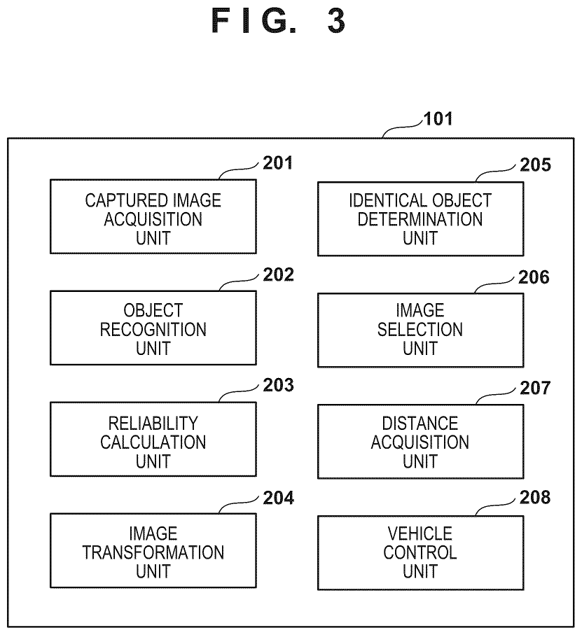

Subsequently, FIG. 3 is a diagram illustrating an example of a functional configuration of an information processing apparatus (ECU 101) included in the autonomous vehicle according to the present embodiment. The information processing apparatus (ECU 101) includes a captured image acquisition unit 201, an object recognition unit 202, a reliability calculation unit 203, an image transformation unit 204, an identical object determination unit 205, an image selection unit 206, a distance acquisition unit 207, and a vehicle control unit 208.

The captured image acquisition unit 201 acquires one or more captured images that have been acquired by each of the six cameras including the forward image capturing camera 104 to the obliquely rearward right image capturing camera 109.

The object recognition unit 202 recognizes an object from the captured image that has been acquired by the captured image acquisition unit 201. For example, a rectangular bounding box that surrounds an object is used. Here, the object may include a fixed obstacle (for example, a building, a curbstone, a wall, a vending machine, a traffic light, or the like) or a moving body (for example, a human, an animal, a bicycle, another vehicle, a car, an electric board, or the like) present in the surroundings of the autonomous vehicle 10. It may be a human as an example.

The reliability calculation unit 203 calculates reliability indicating a probability that an object that has been recognized by the object recognition unit 202 is such an object. For example, in a case where a human (whole body) is recognized as an object, the reliability indicating the probability that the object is really a human is calculated. For example, consideration is given to a case where a part (a lower body) of a human is hidden by an obstacle (for example, a hood of a vehicle).

In this case, the object has been recognized as a human (whole body), but the reliability indicating the probability that the object is really a human (whole body) can be calculated as, for example, 0.5 (in a case where the reliability 1.0 is the highest and the reliability 0 is the lowest). In addition, in a case where the entire body of the human is captured without being hidden by an obstacle, the reliability indicating the probability that the object is a human (entire body) can be calculated as, for example, 0.95. Note that as a method for calculating the reliability, various known methods can be used, and thus details will be omitted.

The image transformation unit 204 performs projective transformation of a point in a captured image by a certain camera into a captured image by another camera. For example, the image transformation unit 204 performs projective transformation of four points respectively indicating positions of four corners representing a bounding box of an object that has been recognized in a captured image by the forward image capturing camera 104 into a captured image by the obliquely forward left image capturing camera 106. Such projective transformation is included, and the projective transformation is performed between the captured images by the six cameras.

The identical object determination unit 205 determines whether an identical object is present in a plurality of captured images. For example, the identical object determination unit 205 determines whether an object that has been recognized in the captured image by the forward image capturing camera 104 and an object that has been recognized in the captured image by the obliquely forward left image capturing camera 106 are an identical object. The determination of whether the objects in the two captured images are identical to each other can be made, for example, as follows.

First, the image transformation unit 204 performs projective transformation of, for example, a first bounding box that surrounds the object that has been recognized in the captured image by the forward image capturing camera 104 into the captured image by the obliquely forward left image capturing camera 106. Then, the identical object determination unit 205 makes determination, based on an overlap ratio between a second bounding box that surrounds the object recognized in the captured image by the obliquely forward left image capturing camera 106 and the first bounding box that has been projective transformed.

For example, the identical object determination unit 205 determines that the identical object is present in the two captured images (in this example, the captured image by the forward image capturing camera 104 and the captured image by the obliquely forward left image capturing camera 106), in a case where the overlap ratio is equal to or larger than a threshold (for example, 50% or 0.5 IoU). As the overlap ratio, for example, Intersection over Union (IoU) may be used. IoU is an index indicating how much two regions overlap each other, and can be obtained by dividing a common part of the two regions by a union of the two regions (0≤IoU≤1).

The image selection unit 206 selects a captured image from which distance information is to be acquired, from a plurality of captured images that have been determined by the identical object determination unit 205 that the identical object is included. For example, the captured image having the highest reliability that has been calculated by the reliability calculation unit 203 is selected.

The distance acquisition unit 207 acquires distance information to the object, based on an object recognition result by the object recognition unit 202 in the captured image that has been selected by the image selection unit 206. The distance acquisition unit 207 acquires the distance information, based on table information in which a position in a captured image is associated with a depth distance from a camera to such a position. For example, by using information of a predetermined position of the bounding box of the object that has been recognized in the captured image, the distance acquisition unit 207 refers to the table information, and acquires the distance information corresponding to such a position.

The predetermined position of the bounding box of the object may be, for example, coordinates of a vertical axis (y axis) in the captured image at a position of the lower side of a rectangle that constitutes the bounding box. Alternatively, by using table information in which each coordinate of the captured image is associated with the distance information, for example, the distance information corresponding to coordinates (x, y) of a midpoint position of the lower side of the rectangle that constitutes the bounding box may be acquired with reference to the table information.

The vehicle control unit 208 controls the movement of the autonomous vehicle 10, based on the distance information that has been acquired by the distance acquisition unit 207. For example, when an object is recognized on a forward side of the vehicle, control is conducted to automatically perform a braking operation (brake operation) and/or a steering operation in order to avoid a collision. In addition, while an object having a collision possibility is not recognized on a forward side of the vehicle, control is conducted to automatically perform an acceleration operation and/or a steering operation, and the vehicle moves to a destination that has been set.

### <Processing>

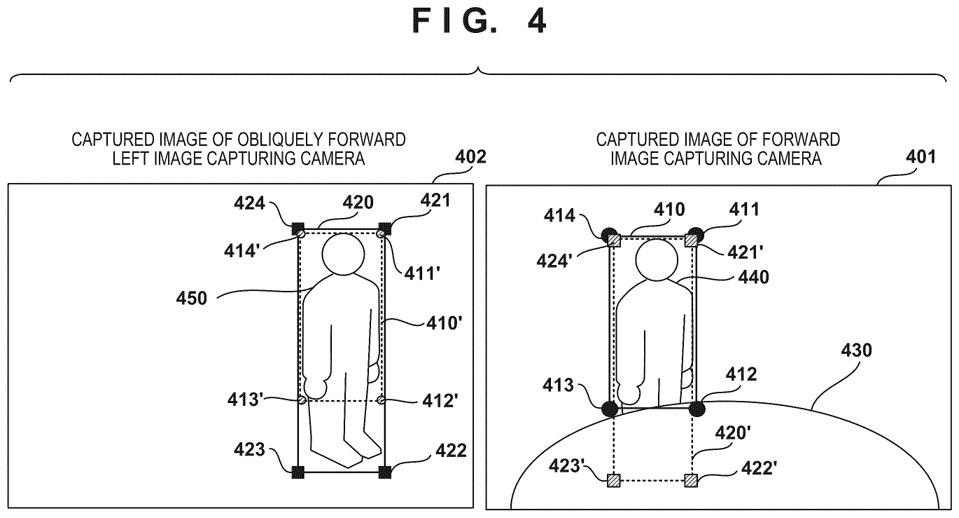

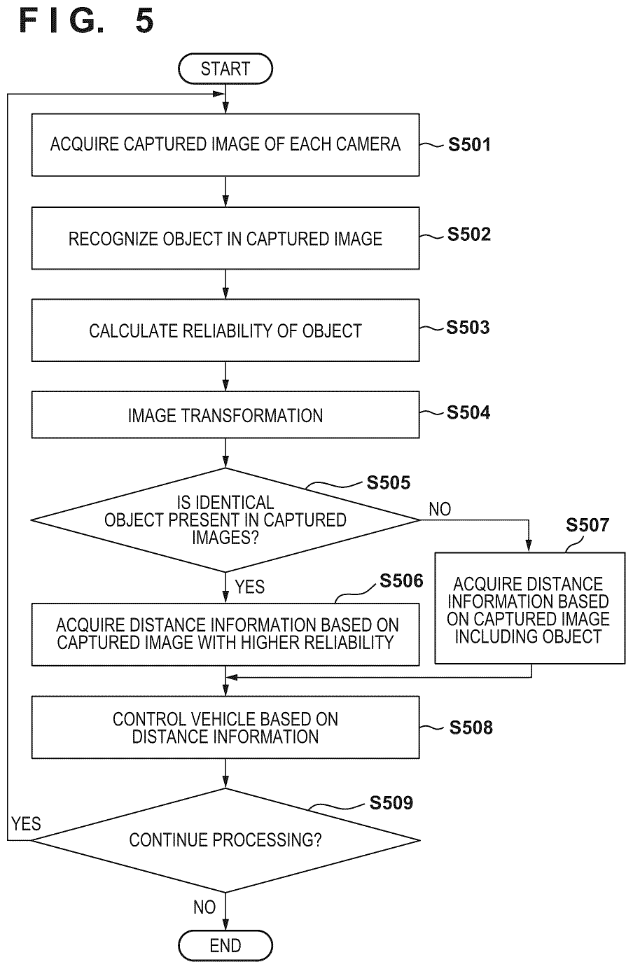

Subsequently, a procedure of processing performed by the information processing apparatus (ECU 101) according to the present embodiment will be described with reference to an explanatory diagram of FIG. 4 and a flowchart of FIG. 5. FIG. 4 is an explanatory diagram of image transformation between captured images according to one embodiment.

In S501, the captured image acquisition unit 201 acquires one or more captured images that have been acquired by each of the six cameras including the forward image capturing camera 104 to the obliquely rearward right image capturing camera 109.

In step S502, the object recognition unit 202 recognizes an object in the captured image that has been acquired by the captured image acquisition unit 201. In the present embodiment, an example of recognizing a human as an object will be described. The object recognition unit 202 recognizes a human, by using a rectangular bounding box. Various methods can be used for the object recognition method. For example, features of humans (whole body) are learned beforehand by machine learning, and it is possible to perform recognition processing, based on whether the feature amount in the bounding box of the object that has been recognized by the object recognition unit 202 conform to the features of the humans (whole body) or how much the feature amount conforms to the features of the humans.

For example, a captured image 401 in FIG. 4 denotes a captured image that has been acquired by the forward image capturing camera 104, and a captured image 402 denotes a captured image that has been acquired by the obliquely forward left image capturing camera 106. The captured images that have been acquired by the other four cameras are also acquired in S501, but the captured images that have been acquired by these two cameras will be described here.

A human 440 whose lower body is partially shielded and invisible by a hood 430 of the autonomous vehicle 10 is recognized from the captured image 401. On the other hand, a human 450 whose entire body is visible is recognized from the captured image 402. It is assumed that no object has been recognized from the captured images that have been acquired by the other cameras.

In S503, the reliability calculation unit 203 calculates the reliability indicating the probability that the object that has been recognized by the object recognition unit 202 from the captured image by each camera is such an object. In the present embodiment, the reliability indicating the probability that the recognized object is really a human is calculated.

For example, as illustrated in the captured image 401, consideration is given to a case where a part (lower body) of the human is hidden by an obstacle (for example, the hood 430 of the vehicle). In this case, although the object is recognized as a human (whole body), the reliability indicating the probability that the object is really a human (whole body) can be calculated as, for example, 0.5. Note that the reliability 1.0 indicates a case where the reliability is the highest, and the reliability 0 indicates a case where the reliability is the lowest. In addition, as illustrated in the captured image 402, in a case where the entire body of the human is captured without being hidden by the obstacle, the reliability indicating the probability that the object is the human (entire body) can be calculated as, for example, 0.95. As a method for calculating the reliability, various known methods can be used.

In S504, the image transformation unit 204 performs projective transformation of a point in a captured image by a certain camera into a captured image by another camera. For example, the image transformation unit 204 performs projective transformation of a bounding box 410 of the object (human 440) that has been recognized in the captured image 401 by the forward image capturing camera 104 into the captured image 402 by the obliquely forward left image capturing camera 106. The bounding box 410 is defined by four points 411, 412, 413, and 414, which respectively indicate the positions of four corners. The bounding box 410 is projective transformed into the captured image 402, and becomes a bounding box 410′, which is defined by four points 411′, 412′, 413′, and 414′.

In step S505, the identical object determination unit 205 determines whether the identical object is present in a plurality of captured images. In a case where it is determined that the identical object is present in the captured images, the processing proceeds to S506. On the other hand, in a case where it is determined that no identical object is present in the captured images, the processing proceeds to S507.

For example, the identical object determination unit 205 determines whether the object that has been recognized in the captured image 401 by the forward image capturing camera 104 and the object that has been recognized in the captured image 402 by the obliquely forward left image capturing camera 106 are an identical object. As illustrated in FIG. 4, the identical object determination unit 205 makes determination, based on an overlap ratio of the feature amount between a second bounding box 420, which surrounds the object that has been recognized in the captured image 402 by the obliquely forward left image capturing camera 106, and the first bounding box 410′, which has been projective transformed. The second bounding box 420 is a rectangle defined by four points 421, 422, 423, and 424. For example, the identical object determination unit 205 determines that an identical object is present in the captured image 401 and the captured image 402, in a case where the overlap ratio is equal to larger than a threshold (for example, 0.5 IoU). In the present embodiment, it is assumed that it has been determined that the identical object is present in the captured image 401 and the captured image 402.

In step S506, the image selection unit 206 selects a captured image from which the distance information is to be acquired from a plurality of captured images that have been determined by the identical object determination unit 205 that the identical object is included. For example, the captured image having the highest reliability that has been calculated by the reliability calculation unit 203 is selected. In the example of FIG. 4, the reliability that has been calculated for the object in the captured image 401 is 0.5 and the reliability calculated for the object in the captured image 402 is 0.95, and thus the captured image 402 is selected. Then, the distance acquisition unit 207 acquires distance information to the object, based on the object recognition result by the object recognition unit 202 for the captured image that has been selected by the image selection unit 206. For example, the distance information is acquired, based on table information in which a position in the captured image is associated with a depth distance from the camera to such a position. It is assumed that table information is held for every camera. The content of the table information is not limited to this, and may be a table including a depth distance from a front end or a rear end of the autonomous vehicle 10 to such a position.

In the example of FIG. 4, the distance information in the table information of the captured image 402 (the obliquely forward left image capturing camera 106) corresponding to a position of a straight line that connect the two points 422 and 423 on a lower side of the bounding box 420 of the captured image 402 is acquired.

In step S507, the image selection unit 206 selects a captured image including an object. The distance acquisition unit 207 acquires distance information to the object, based on an object recognition result by the object recognition unit 202 in the captured image that has been selected by the image selection unit 206. A method for acquiring the distance information is similar to that in S506, and the distance information can be acquired, based on the table information corresponding to the captured image (camera) that has been selected by the image selection unit 206.

In S508, the vehicle control unit 208 controls the movement of the autonomous vehicle 10, based on the distance information that has been acquired by the distance acquisition unit 207. For example, when an object is recognized on a forward side of the vehicle, control is conducted to automatically perform a braking operation (brake operation) and/or a steering operation in order to avoid a collision.

In S509, the information processing apparatus (ECU 101) determines whether to continue the processing. In a case of continuing the processing, the processing returns to S501. On the other hand, in a case of not continuing the processing, a series of processing in FIG. 5 ends. For example, when the autonomous vehicle 10 reaches a destination that has been set or when a predetermined operation is performed by an occupant of the autonomous vehicle 10, the processing may end.

Note that the order of the processing in the flowchart is not limited to the described order, and may have another order. In addition, any other processing may be appropriately added, or some processing may be skipped or excluded.

As described heretofore, in the present embodiment, in a case where it is determined that the identical object is present in the plurality of captured images, the distance information to the object is acquired, based on the object recognition result in the captured image having higher reliability indicating the probability that the object is such an object.

Accordingly, the distance to the object in the captured image is accurately acquirable from the captured image suitable for acquiring the distance information. For example, in a case where an object is partially shielded by the hood of the vehicle or another object in a captured image by a camera that captures an image on a forward side of the vehicle, it becomes possible to suppress the distance to the object from being erroneously acquired. Therefore, highly accurate control can be conducted, also in autonomous control of the vehicle with use of the acquired distance information.

### [Modifications]

In the above-described embodiment, an example in which the captured image having the higher reliability is selected in S506 and the distance information is acquired, based on the captured image has been described. However, the present invention is not limited to this example. In the example of FIG. 4, it is determined that the captured image 402 has higher reliability. However, the object (human) is located closer to the front surface of the forward image capturing camera 104 than to the obliquely forward left image capturing camera. Therefore, the distance information with higher accuracy can be acquired by acquiring the distance information, based on the captured image 401 by the forward image capturing camera 104.

Therefore, as illustrated in FIG. 4, the bounding box 420 in the captured image 402 may be projective transformed into the captured image 401 by the image transformation unit 204. Then, the distance information may be acquired from the positions of the lower side of four points 421′, 422′, 423′, and 424′ of a bounding box 420′, which has been projective transformed, and the table information corresponding to the captured image 401 (forward image capturing camera 104).

In addition, with regard to the table information corresponding to which captured image (camera) can be used, the priority may be determined beforehand for every camera. For example, the priority of the forward image capturing camera 104 may be set to be higher than the priority of the obliquely forward left image capturing camera 106, and the priority of the forward image capturing camera 104 may be set to be higher than the priority of the obliquely forward right image capturing camera 108. Similarly, the priority of the rearward image capturing camera 105 may be set to be higher than the priority of the obliquely rearward left image capturing camera 107, and the priority of the rearward image capturing camera 105 may be set to be higher than the priority of the obliquely rearward right image capturing camera 109.

In addition, in S506, in a case where the reliability that has been calculated by the reliability calculation unit 203 for each captured image is substantially the same, that is, a case where the difference in reliability is equal to or smaller than the threshold is also assumed. In this case, the distance acquisition unit 207 may acquire the distance information to the object, based on the object recognition result by the object recognition unit 202 for the captured image in which the position of the object in the captured image is closer to the center position of the captured image. This is because more accurate distance information is acquirable at a position closer to the center of the captured image. For example, the distance information to the object may be acquired, based on the object recognition result by the object recognition unit 202 for the captured image in which the distance between the position of the gravity center of the bounding box of the object and the center position of the captured image is shorter.

In addition, in S507, the identical object is not included in the plurality of captured images, and thus the distance information to the object in a certain captured image is acquired with use of the table information corresponding to the captured image (camera). There is a possibility that the accuracy of the distance information is low. Therefore, in such a case, the content of the vehicle control based on the object recognition result may be changed. For example, while the vehicle is close to the object by a predetermined distance, the value of the predetermined distance for performing an avoidance operation by performing the braking operation and/or the steering operation may be changed to a larger value. Accordingly, the avoidance operation can be performed promptly in a location apart from the object, so that safety can be improved.

Further, in a case where the identical object is not included in the plurality of captured images, and the reliability indicating the probability that the object that has been detected in a certain captured image is such an object is low, and is equal to or smaller than a predetermined value, the frame of a captured image before the frame of such a captured image may be referred to. For example, the movement of the object in the captured image may be tracked, the position of the bounding box, in the captured image of a current frame, corresponding to the time when the entire object (for example, the entire body of a human) was recognized may be estimated, and the distance information may be acquired from the table information, based on the estimated position.

Further, in the above-described embodiment, the processing in accordance with whether the identical object is included in the captured image by the forward image capturing camera 104 and the captured image by the obliquely forward left image capturing camera 106 (or the obliquely forward right image capturing camera 108) has been described. However, the present invention is not limited to this example. Similarly, similar processing can be performed in accordance with whether the identical object is included in the captured image by the rearward image capturing camera 105 and the captured image by the obliquely rearward left image capturing camera 107 (or the obliquely rearward right image capturing camera 109). Furthermore, similar processing can be performed in accordance with whether the identical object is included in the captured image by the obliquely forward left image capturing camera 106 and the captured image by the obliquely rearward left image capturing camera 107. Then, similar processing can be performed in accordance with whether the identical object is included in the captured image by the obliquely forward right image capturing camera 108 and the captured image by the obliquely rearward right image capturing camera 109. In addition, similar processing can be performed in accordance with whether the identical object is included in the captured images by three or more cameras.

According to the present invention, the distance to the object is accurately acquirable.
1. The information processing apparatus (101) according to the above embodiments is an information processing apparatus comprising:
   an image acquisition unit (201) configured to acquire a first captured image (401) by a first camera (104) and a second captured image (402) by a second camera (106);
   an object recognition unit (202) configured to recognize an object from each the first captured image and the second captured image;
   a reliability calculation unit (203) configured to calculate reliability indicating a probability that the object is the object for each the first captured image and the second captured image;
   a determination unit (205) configured to determine whether an identical object is present in the first captured image and the second captured image; and
   a distance acquisition unit (207) configured to acquire distance information to the object, based on an object recognition result by the object recognition unit for a captured image having higher reliability calculated by the reliability calculation unit, in a case where the determination unit determines that the identical object is present.

Accordingly, the distance to the object in the captured image is accurately acquirable from the captured image suitable for acquiring the distance information.
2. The information processing apparatus (101) according to the above embodiments, further comprising
   a transformation unit (204) configured to perform projective transformation of a first bounding box (410) that surrounds the object recognized in the first captured image into the second captured image, wherein
   the determination unit makes determination, based on an overlap ratio (IoU) between a second bounding box (420) that surrounds the object recognized in the second captured image and the first bounding box that has been projective transformed.

Accordingly, the overlap ratio between the objects (bounding boxes) is accurately obtainable, so that whether the objects are an identical object can be accurately determined.
3. In the information processing apparatus (101) according to the above embodiments, in a case where the overlap ratio is equal to or larger than a threshold, the determination unit determines that the identical object is present in the first captured image and the second captured image.

Accordingly, whether the objects in the captured images are the identical object can be easily determined.
4. In the information processing apparatus (101) according to the above embodiments, the distance acquisition unit acquires the distance information, based on a predetermined position of a bounding box in a captured image having higher reliability, out of the first bounding box in the first captured image and the second bounding box in the second captured image.

This enables acquisition of more accurate distance information.
5. In the information processing apparatus (101) according to the above embodiments, the predetermined position is a position of a lower side that constitutes the bounding box.

In this manner, by using a position of the lower side of the bounding box of the object (for example, the human) (the position of a foot of the human) as a reference, the distance information from the camera to such a position (the position of the ground) is accurately acquirable.
6. In the information processing apparatus (101) according to the above embodiments,
   the first camera is a camera (104) disposed on a front side of an autonomous vehicle (10) including the information processing apparatus, and configured to capture an image on a forward side of the autonomous vehicle, and
   the second camera is a camera (106, 108) disposed on either a left lateral side or a right lateral side of the autonomous vehicle, and configured to capture an image on either an obliquely forward left side or an obliquely forward right side of the autonomous vehicle,
   the information processing apparatus further comprising a second transformation unit (204) configured to perform projective transformation of a second bounding box (420) that surrounds the object recognized in the second captured image into the first captured image, in a case where second reliability of the object recognized in the second captured image is higher than first reliability of the object recognized in the first captured image, wherein
   the distance acquisition unit acquires the distance information, based on a predetermined position of the second bounding box (420′) that has been projective transformed.

Accordingly, it becomes possible to acquire the distance information, by using the captured image by the forward image capturing camera capable of acquiring more accurate distance information from the position of the object in the captured image.
7. In the information processing apparatus (101) according to the above embodiments, the object is not partially recognized in the first captured image, and the object is entirely recognized in the second captured image.

In this manner, it becomes possible to acquire accurate distance information, by using a captured image in which the object is entirely recognized, instead of a captured image in which the object is not partially recognized by a shielding object or the like. In addition, in a case where the distance information is acquired with use of a captured image in which the object is not partially recognized, there is a possibility that erroneous distance information will be acquired, for example, when the distance information is acquired with use of the table information in which a predetermined position of the object (for example, a foot of a human) in the captured image is associated with the distance information at such a position in the captured image. However, according to such a characteristic, the acquisition of such erroneous distance information can be suppressed.
8. In the information processing apparatus (101) according to the above embodiments, the predetermined position is a position of a lower side that constitutes the second bounding box that has been projective transformed.

In this manner, by using a position of the lower side of the bounding box of the object (for example, the human) (the position of a foot of the human) as a reference, the distance information from the camera to such a position (the position of the ground) is accurately acquirable.
9. In the information processing apparatus (101) according to the above embodiments,
   the first camera is a camera (105) disposed on a rear side of an autonomous vehicle (10) including the information processing apparatus, and configured to capture an image on a rearward side of the autonomous vehicle, and
   the second camera is a camera (107, 109) disposed on either a left lateral side or a right lateral side of the autonomous vehicle, and configured to capture an image of either an obliquely rearward left side or an obliquely rearward right side of the autonomous vehicle,
   the information processing apparatus further comprising a second transformation unit (204) configured to perform projective transformation of a second bounding box that surrounds the object recognized in the second captured image into the first captured image, in a case where second reliability of the object recognized in the second captured image is higher than first reliability of the object recognized in the first captured image, wherein
   the distance acquisition unit acquires the distance information, based on a predetermined position of the second bounding box that has been projective transformed.

Accordingly, it becomes possible to acquire the distance information, by using the captured image by the rearward image capturing camera capable of acquiring more accurate distance information from the position of the object in the captured image.
10. In the information processing apparatus (101) according to the above embodiments, the object is not partially recognized in the first captured image, and the object is entirely recognized in the second captured image.

In this manner, it becomes possible to acquire accurate distance information, by using a captured image in which the object is entirely recognized, instead of a captured image in which the object is not partially recognized by a shielding object or the like. In addition, in a case where the distance information is acquired with use of a captured image in which the object is not partially recognized, there is a possibility that erroneous distance information will be acquired, for example, when the distance information is acquired with use of the table information in which a predetermined position of the object (for example, a foot of a human) in the captured image is associated with the distance information at such a position in the captured image. However, according to such a characteristic, the acquisition of such erroneous distance information can be suppressed.
11. In the information processing apparatus (101) according to the above embodiments, the predetermined position is a position of a lower side that constitutes the second bounding box that has been projective transformed.

In this manner, by using a position of the lower side of the bounding box of the object (for example, the human) (the position of a foot of the human) as a reference, the distance information from the camera to such a position (the position of the ground) is accurately acquirable. In addition, by using the position of the lower side of the bounding box that has been projective transformed, it becomes possible to recognize the position of the foot of the human appropriately, also in a case where the lower body of the human is hidden by, for example, the hood in the captured image that has been projective transformed. Therefore, it becomes possible to acquire accurate distance information.
12. In the information processing apparatus (101) according to the above embodiments, the distance acquisition unit acquires the distance information, based on table information in which a position in a captured image is associated with a depth distance from a camera to the position.

Accordingly, the distance information to the object can be easily acquired, as long as the predetermined position of the object in the captured image is known.
13. In the information processing apparatus (101) according to the above embodiments, in a case where the determination unit determines that no identical object is present, the distance acquisition unit acquires the distance information to each object, based on an object recognition result by the object recognition unit for each captured image.

Accordingly, even in a case where no identical object is present, it becomes possible to acquire distance information from each camera to the object included in each captured image.
14. In the information processing apparatus (101) according to the above embodiments, in a case where a difference in reliability calculated by the reliability calculation unit is equal to or smaller than a threshold, the distance acquisition unit acquires the distance information to the object, based on an object recognition result by the object recognition unit for a captured image in which a position of the object in the captured image is closer to a center position of the captured image.

In this manner, in a case where there is almost no difference in reliability (that is, in a case where shielding degrees of an object are almost the same or in a case where none of the objects is shielded), it becomes possible to acquire the distance information accurately, by using the captured image in which the object can be captured from a position closer to the front surface of the camera.
15. The autonomous vehicle (10) according to the above embodiments is an autonomous vehicle comprising the information processing apparatus (101) according to the above embodiments, the autonomous vehicle comprising:
   a vehicle control unit (208) configured to control movement of the autonomous vehicle based on the distance information acquired by the distance acquisition unit.

Accordingly, automatic control of the vehicle is enabled by assuming the object recognition with high accuracy, and automatic control with improved safety of occupants and/or humans outside the vehicle is enabled.
16. The control method of an information processing apparatus (101) according to the above embodiments, comprising:
   acquiring (S501) a first captured image (401) by a first camera (104) and a second captured image (402) by a second camera (106);
   recognizing (S502) an object from each the first captured image and the second captured image;
   calculating (S503) reliability indicating a probability that the object is the object for each the first captured image and the second captured image;
   determining (S505) whether an identical object is present in the first captured image and the second captured image; and
   acquiring (S506) distance information to the object, based on an object recognition result by the recognizing for a captured image having higher reliability calculated by the calculating, in a case where the determining determines that the identical object is present.

Accordingly, the distance to the object in the captured image is accurately acquirable from the captured image suitable for acquiring the distance information.
17. The program in the above embodiment is a program for causing a computer to function as the information processing apparatus in the above embodiment.

Accordingly, the functions of the information processing apparatus are achievable as a program.
18. The storage medium in the above embodiment is a non-transitory computer-readable storage medium storing a program for causing a computer to function as an information processing apparatus in the above embodiment.

Accordingly, the functions of the information processing apparatus are achievable as a storage medium.

### Other Embodiments

In addition, a program for achieving one or more functions that have been described in each of the embodiments is supplied to a system or an apparatus through a network or via a storage medium, and one or more processors on a computer of the system or the apparatus are capable of reading and executing the program. The present invention is also achievable in such an aspect.

The invention is not limited to the foregoing embodiments, and various variations/changes are possible within the spirit of the invention.

What is claimed is:

1. An information processing apparatus comprising:
an image acquisition unit configured to acquire a first captured image by a first camera and a second captured image by a second camera;
an object recognition unit configured to recognize an object from each the first captured image and the second captured image;
a reliability calculation unit configured to calculate reliability indicating a probability that the object is the object for each the first captured image and the second captured image;
a determination unit configured to determine whether an identical object is present in the first captured image and the second captured image; and
a distance acquisition unit configured to acquire distance information to the object, based on an object recognition result by the object recognition unit for a captured image having higher reliability calculated by the reliability calculation unit, in a case where the determination unit determines that the identical object is present.

2. The information processing apparatus according to claim 1, further comprising
a transformation unit configured to perform projective transformation of a first bounding box that surrounds the object recognized in the first captured image into the second captured image, wherein
the determination unit makes determination, based on an overlap ratio between a second bounding box that surrounds the object recognized in the second captured image and the first bounding box that has been projective transformed.

3. The information processing apparatus according to claim 2, wherein in a case where the overlap ratio is equal to or larger than a threshold, the determination unit determines that the identical object is present in the first captured image and the second captured image.

4. The information processing apparatus according to claim 2, wherein the distance acquisition unit acquires the distance information, based on a predetermined position of a bounding box in a captured image having higher reliability, out of the first bounding box in the first captured image and the second bounding box in the second captured image.

5. The information processing apparatus according to claim 4, wherein the predetermined position is a position of a lower side that constitutes the bounding box.

6. The information processing apparatus according to claim 1, wherein
the first camera is a camera disposed on a front side of an autonomous vehicle including the information processing apparatus, and configured to capture an image on a forward side of the autonomous vehicle, and
the second camera is a camera disposed on either a left lateral side or a right lateral side of the autonomous vehicle, and configured to capture an image on either an obliquely forward left side or an obliquely forward right side of the autonomous vehicle,
the information processing apparatus further comprising a second transformation unit configured to perform projective transformation of a second bounding box that surrounds the object recognized in the second captured image into the first captured image, in a case where second reliability of the object recognized in the second captured image is higher than first reliability of the object recognized in the first captured image, wherein
the distance acquisition unit acquires the distance information, based on a predetermined position of the second bounding box that has been projective transformed.

7. The information processing apparatus according to claim 6, wherein the object is not partially recognized in the first captured image, and the object is entirely recognized in the second captured image.

8. The information processing apparatus according to claim 6, wherein the predetermined position is a position of a lower side that constitutes the second bounding box that has been projective transformed.

9. The information processing apparatus according to claim 1, wherein
the first camera is a camera disposed on a rear side of an autonomous vehicle including the information processing apparatus, and configured to capture an image on a rearward side of the autonomous vehicle, and
the second camera is a camera disposed on either a left lateral side or a right lateral side of the autonomous vehicle, and configured to capture an image of either an obliquely rearward left side or an obliquely rearward right side of the autonomous vehicle,
the information processing apparatus further comprising a second transformation unit configured to perform projective transformation of a second bounding box that surrounds the object recognized in the second captured image into the first captured image, in a case where second reliability of the object recognized in the second captured image is higher than first reliability of the object recognized in the first captured image, wherein
the distance acquisition unit acquires the distance information, based on a predetermined position of the second bounding box that has been projective transformed.

10. The information processing apparatus according to claim 9, wherein the object is not partially recognized in the first captured image, and the object is entirely recognized in the second captured image.

11. The information processing apparatus according to claim 9, wherein the predetermined position is a position of a lower side that constitutes the second bounding box that has been projective transformed.

12. The information processing apparatus according to claim 1, wherein the distance acquisition unit acquires the distance information, based on table information in which a position in a captured image is associated with a depth distance from a camera to the position.

13. The information processing apparatus according to claim 1, wherein in a case where the determination unit determines that no identical object is present, the distance acquisition unit acquires the distance information to each object, based on an object recognition result by the object recognition unit for each captured image.

14. The information processing apparatus according to claim 1, wherein in a case where a difference in reliability calculated by the reliability calculation unit is equal to or smaller than a threshold, the distance acquisition unit acquires the distance information to the object, based on an object recognition result by the object recognition unit for a captured image in which a position of the object in the captured image is closer to a center position of the captured image.

15. An autonomous vehicle comprising:
the information processing apparatus according to claim 1; and
a vehicle control unit configured to control movement of the autonomous vehicle based on the distance information acquired by the distance acquisition unit.

16. A control method of an information processing apparatus, the control method comprising:
acquiring a first captured image by a first camera and a second captured image by a second camera;
recognizing an object from each the first captured image and the second captured image;
calculating reliability indicating a probability that the object is the object for each the first captured image and the second captured image;
determining whether an identical object is present in the first captured image and the second captured image; and
acquiring distance information to the object, based on an object recognition result by the recognizing for a captured image having higher reliability calculated by the calculating, in a case where the determining determines that the identical object is present.

17. A non-transitory computer-readable storage medium storing a program for causing a computer to execute a control method of an information processing apparatus, the control method comprising:
acquiring a first captured image by a first camera and a second captured image by a second camera;
recognizing an object from each the first captured image and the second captured image;
calculating reliability indicating a probability that the object is the object for each the first captured image and the second captured image;
determining whether an identical object is present in the first captured image and the second captured image; and
acquiring distance information to the object, based on an object recognition result by the recognizing for a captured image having higher reliability calculated by the calculating, in a case where the determining determines that the identical object is present.
